(19) United States
(12) Patent Application Publication
(10) Pub. No.: US 2025/0153808 A1
(43) Pub. Date: May 15, 2025

(54) CONTROL DEVICE FOR HUMAN-POWERED VEHICLE

(71) Applicant: Shimano Inc., Osaka (JP)

(72) Inventor: Satoshi SHAHANA, Osaka (JP)

(21) Appl. No.: 18/901,898

(22) Filed: Sep. 30, 2024

(30) Foreign Application Priority Data
Nov. 14, 2023 (JP) 2023-193689

(51) Int. Cl. B62M 25/08; B62M 6/50; B62M 6/55

(52) U.S. Cl. CPC B62M 25/08; B62M 6/50; B62M 6/55

(57) ABSTRACT

A control device for a human-powered vehicle includes an electronic controller configured to control a transmission device. The transmission device is configured to shift a transmission ratio that is a ratio of a wheel rotational speed of a drive wheel of the human-powered vehicle to a crank rotational speed of a crank axle of the human-powered vehicle. The electronic controller is configured to control the transmission device so as to restrict a first shifting action that increases the transmission ratio in a case where a pitch change amount is greater than or equal to a first change amount. The pitch change amount is a change amount of a pitch angle of the human-powered vehicle.

### CROSS-REFERENCE TO RELATED APPLICATIONS

This application claims priority to Japanese Patent Application No. 2023-193689, filed on Nov. 14, 2023. The entire disclosure of Japanese Patent Application No. 2023-193689 is hereby incorporated herein by reference.

### BACKGROUND

### Technical Field

The present invention generally relates to a control device for a human-powered vehicle.

### Background Information

Japanese Laid-Open Patent Publication No. 2019-209970 (Patent Document 1) discloses an example of a control device configured to control at least one of a transmission device and a motor. The transmission device shifts a transmission ratio of a human-powered vehicle. The drive unit includes a motor configured to apply propulsion force to the human-powered vehicle.

### SUMMARY

One objective of the present disclosure is to provide a control device that controls a human-powered vehicle component in a preferred manner.

A control device in accordance with a first aspect of the present disclosure is for a human-powered vehicle. The control device comprises an electronic controller configured to control a transmission device. The transmission device is configured to shift a transmission ratio that is a ratio of a wheel rotational speed of a drive wheel of the human-powered vehicle to a crank rotational speed of a crank axle of the human-powered vehicle. The electronic controller is configured to control the transmission device so as to restrict a first shifting action that increases the transmission ratio in a case where a pitch change amount is greater than or equal to a first change amount. The pitch change amount is a change amount of a pitch angle of the human-powered vehicle.

With the control device according to the first aspect, in a case where the pitch change amount is greater than or equal to the first change amount, the electronic controller restricts the first shifting action so that the load on the rider does not increase. Thus, the electronic controller controls the human-powered vehicle component in a preferred manner.

In accordance with a second aspect of the present disclosure, in the control device according to the first aspect, the electronic controller is configured to control the transmission device so as to restrict the first shifting action and not restrict a second shifting action that decreases the transmission ratio in a case where the pitch change amount is greater than or equal to the first change amount.

With the control device according to the second aspect, in a case where the pitch change amount is greater than or equal to the first change amount, the electronic controller restricts the first shifting action so that the load on the rider does not increase. With the control device according to the second aspect, in a case where the pitch change amount is greater than or equal to the first change amount, the electronic controller performs the second shifting action in the same manner as in a case where the second shifting action is not restricted. Thus, the load on the rider can be reduced.

In accordance with a third aspect of the present disclosure, in the control device according to the second aspect, the electronic controller is configured to control the transmission device so as to shift the transmission ratio in accordance with at least one of the crank rotational speed, a human driving force applied to the crank axle, and a vehicle speed of the human-powered vehicle.

With the control device according to the third aspect, the electronic controller appropriately shifts the transmission ratio in accordance with at least one of the crank rotational speed, the human driving force, and the vehicle speed.

In accordance with a fourth aspect of the present disclosure, in the control device according to the third aspect, the electronic controller is configured to control the transmission device so as to shift the transmission ratio based on a comparison of the at least one of the crank rotational speed, the human driving force, and the vehicle speed with a threshold value. The electronic controller is configured to restrict the first shifting action by increasing the threshold value in a case where the pitch change amount is greater than or equal to the first change amount.

With the control device according to the fourth aspect, in a case where the pitch change amount is greater than or equal to the first change amount, the electronic controller restricts the first shifting action by changing the threshold value.

In accordance with a fifth aspect of the present disclosure, in the control device according to the third aspect, the electronic controller is configured so as not to perform the first shifting action regardless of the least one of the crank rotational speed, the human driving force, and the vehicle speed in a case where the pitch change amount is greater than or equal to the first change amount.

With the control device according to the fifth aspect, in a case where the pitch change amount is greater than or equal to the first change amount, the electronic controller prohibits the first shifting action. Thus, an increase in the load on the rider is avoided in a more preferred manner.

In accordance with a sixth aspect of the present disclosure, in the control device according to any one of the first to fifth aspects, the electronic controller is configured to control the transmission device so as to restrict the first shifting action in a case where the pitch change amount is greater than or equal to the first change amount and a crank rotational speed change amount is greater than or equal to a predetermined crank rotational speed change amount. The crank rotational speed change amount is a change amount of the crank rotational speed.

With the control device according to the sixth aspect, in a case where the pitch change amount is greater than or equal to the first change amount and the crank rotational speed change amount is greater than or equal to the predetermined crank rotational speed change amount, the electronic controller restricts the first shifting action so that the load on the rider does not increase.

In accordance with a seventh aspect of the present disclosure, in the control device according to any one of the first to sixth aspects, the electronic controller is configured to control the transmission device so as to restrict the first shifting action in a case where the pitch change amount is greater than or equal to the first change amount and a human driving force applied to the crank axle is greater than or equal to a predetermined human driving force.

With the control device according to the seventh aspect, in a case where the pitch change amount is greater than or equal to the first change amount and the human driving force is greater than or equal to the predetermined human driving force, the electronic controller restricts the first shifting action so that the load on the rider does not increase.

In accordance with an eighth aspect of the present disclosure, in the control device according to any one of the first to seventh aspects, the electronic controller is configured to control the transmission device so as to restrict the first shifting action in a case where the pitch change amount is greater than or equal to the first change amount and a vehicle speed of the human-powered vehicle is greater than or equal to a predetermined vehicle speed.

With the control device according to the eighth aspect, in a case where the pitch change amount is greater than or equal to the first change amount and the vehicle speed is greater than or equal to the predetermined vehicle speed, the electronic controller restricts the first shifting action, which can increase a load on the rider.

In accordance with a ninth aspect of the present disclosure, in the control device according to any one of the first to eighth aspects, the electronic controller is configured to control the transmission device so as to restrict the first shifting action upon the pitch change amount being greater than or equal to the first change amount in a case where the pitch angle increases.

With the control device according to the ninth aspect, in a case where the pitch angle increases, if the pitch change amount is greater than or equal to the first change amount, the electronic controller restricts the first shifting action, which can increase a load on the rider.

In accordance with a tenth aspect of the present disclosure, in the control device according to any one of the first to ninth aspects, the electronic controller is configured to control the transmission device so as to restrict the first shifting action upon the pitch change amount being greater than or equal to the first change amount in a case where the pitch angle decreases.

With the control device according to the tenth aspect, in a case where the pitch angle decreases, if the pitch change amount is greater than or equal to the first change amount, the electronic controller restricts the first shifting action, which can increase a load on the rider.

In accordance with an eleventh aspect of the present disclosure, in the control device according to any one of the first to tenth aspects, the electronic controller is configured to control a motor that is configured to apply a propulsion force to the human-powered vehicle. The electronic controller is configured to reduce at least one of an assist ratio that is a ratio of an output of the motor to a human driving force applied to the crank axle, an upper limit value of the output of the motor, and the output of the motor in a case where an inclination change amount that is a change amount of an inclination angle of the human-powered vehicle is greater than or equal to a second change amount.

With the control device according to the eleventh aspect, in a case where the inclination change amount is greater than or equal to the second change amount, the electronic controller reduces at least one of the assist ratio, the upper limit value of an output of the motor, and the output of the motor.

In accordance with a twelfth aspect of the present disclosure, the control device according to the eleventh aspect is configured so that the inclination angle includes the pitch angle. The inclination change amount includes the pitch change amount. The electronic controller is configured to reduce the at least one of the assist ratio, the upper limit value, and the output of the motor in a case where the pitch change amount is greater than or equal to a second change amount.

With the control device according to the twelfth aspect, in a case where the pitch change amount is greater than or equal to the second change amount, the electronic controller reduces at least one of the assist ratio, the upper limit value of an output of the motor, and the output of the motor.

In accordance with a thirteenth aspect of the present disclosure, in the control device according to the eleventh or twelfth aspect, the second change amount is the first change amount.

With the control device according to the thirteenth aspect, in a case where the pitch change amount is greater than or equal to the first change amount, the electronic controller restricts the first shifting action and also reduces at least one of the assist ratio, the upper limit value of an output of the motor, and the output of the motor.

In accordance with a fourteenth aspect of the present disclosure, in the control device according to any one of the first to thirteenth aspect, the electronic controller is configured to calculate the pitch angle based on an output of a first detector that is configured to detect the pitch angle and an output of a second detector that differs from the first detector and is configured to detect the pitch angle.

With the control device according to the fourteenth aspect, the electronic controller calculates the pitch angle in a preferred manner.

In accordance with a fifteenth aspect of the present disclosure, the control device according to the fourteenth aspect is configured so that the first detector includes an acceleration sensor.

With the control device according to the fifteenth aspect, the pitch angle is appropriately calculated from an output of the acceleration sensor.

In accordance with a sixteenth aspect of the present disclosure, the control device according to the fourteenth or fifteenth aspect is configured so that the second detector includes a gyro sensor.

With the control device according to the sixteenth aspect, the pitch angle is appropriately calculated from an output of the gyro sensor.

A control device in accordance with a seventeenth aspect of the present disclosure is for a human-powered vehicle a transmission device, a motor, a first detector including an acceleration sensor, and a second detector including a gyro sensor. The transmission device is configured to shift a transmission ratio that is a ratio of a wheel rotational speed of a drive wheel of the human-powered vehicle to a crank rotational speed of a crank axle of the human-powered vehicle. The motor is configured to apply a propulsion force to the human-powered vehicle. The control device comprises an electronic controller configured to control at least one of the transmission device and the motor. The electronic controller is configured to calculate an inclination angle of the human-powered vehicle from an output of the first detector and an output of the second detector. The electronic controller is configured to perform at least one of a restriction of a first shifting action that increases the transmission ratio, a reduction of an assist ratio that is a ratio of an output of the motor to a human driving force applied to the crank axle, a reduction of an upper limit value of the output of the motor, and a reduction of the output of the motor in a case where an inclination change amount that is a change amount of the inclination angle is greater than or equal to a third change amount.

With the control device according to the seventeenth aspect, in a case where the pitch change amount is greater than or equal to the third change amount, the electronic controller restricts the first shifting action, which can increase a load on the rider, and also reduces at least one of the assist ratio, the upper limit value of an output of the motor, and the output of the motor. Thus, the electronic controller appropriately controls the human-powered vehicle component.

In accordance with an eighteenth aspect of the present disclosure, in the control device according to the seventeenth aspect, the acceleration sensor is configured to detect acceleration related to a first axis of the human-powered vehicle. The gyro sensor is configured to detect angular velocity related to a second axis of the human-powered vehicle. The second axis is orthogonal to the first axis. The electronic controller is configured to calculate the inclination change amount from the angular velocity detected by the gyro sensor and an estimated value of the inclination angle that is calculated based on the acceleration detected by acceleration sensor.

With the control device according to the eighteenth aspect, the electronic controller appropriately calculates the inclination change amount from the angular velocity and the estimated value of the inclination angle calculated from the acceleration.

In accordance with a nineteenth aspect of the present disclosure, the control device according to the eighteenth aspect is configured so that the inclination angle includes a pitch angle of the human-powered vehicle. The inclination change amount includes a pitch change amount of the pitch angle. The electronic controller is configured to calculate the pitch change amount from the angular velocity detected by the gyro sensor and an estimated value of the pitch angle that is calculated based on the acceleration detected by the acceleration sensor.

With the control device according to the nineteenth aspect, the electronic controller appropriately calculates the pitch change amount from the angular velocity and the estimated value of the pitch angle calculated from the acceleration.

In accordance with a twentieth aspect of the present disclosure, in the control device according to any one of the seventeenth to nineteenth aspects, the electronic controller is configured to perform at least one of a restriction of the first shifting action, a reduction of the assist ratio, a reduction of the upper limit value, and a reduction of the output of the motor upon the inclination change amount being greater than or equal to the third change amount in a case where the inclination angle increases.

With the control device according to the twentieth aspect, in a case where the inclination angle increases and the inclination change amount is greater than or equal to the third change amount, the electronic controller restricts the first shifting action so that the load on the rider does not increase, and also reduces at least one of the assist ratio, the upper limit value of an output of the motor, and the output of the motor.

In accordance with a twenty-first aspect of the present disclosure, in the control device according to any one of the seventeenth to twentieth aspects, the electronic controller is configured to perform at least one of a restriction of the first shifting action, a reduction of the assist ratio, a reduction of the upper limit value, and a reduction of the output of the motor upon the inclination change amount being greater than or equal to the third change amount in a case where the inclination angle decreases.

With the control device according to the twenty-first aspect, in a case where the inclination angle decreases and the inclination change amount is greater than or equal to the third change amount, the electronic controller restricts the first shifting action so that the load on the rider does not increase, and also reduces at least one of the assist ratio, the upper limit value of an output of the motor, and the output of the motor.

The human-powered vehicle control device according to the present disclosure controls a human-powered vehicle component in a preferred manner.

### BRIEF DESCRIPTION OF THE DRAWINGS

Referring now to the attached drawings which form a part of this original disclosure.

FIG. 1 is a side elevational view of a human-powered vehicle including a human-powered vehicle control device in accordance with a first embodiment.

FIG. 2 is a block diagram showing the electrical configuration of a human-powered vehicle including a first embodiment of a control device for a human-powered vehicle.

FIG. 3 is a flowchart of a process executed by an electronic controller shown in FIG. 2 for shifting a transmission ratio of a transmission device.

FIG. 4 is a flowchart of a process executed by the electronic controller shown in FIG. 2 for controlling the transmission device in accordance with a pitch change amount.

FIG. 5 is a flowchart of a process executed by an electronic controller in a second embodiment for controlling a motor in accordance with a pitch change amount.

FIG. 6 is a flowchart of a process executed by an electronic controller in a third embodiment for controlling a transmission device and a motor in accordance with a pitch change amount.

FIG. 7 is a flowchart of a process executed by an electronic controller in a first modification for controlling a transmission device in accordance with a pitch change amount.

FIG. 8 is a flowchart of a process executed by a controller in a second modification for controlling a transmission device in accordance with a pitch change amount.

FIG. 9 is a flowchart of a process executed by a controller in a third modification for controlling a transmission device in accordance with a pitch change amount.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

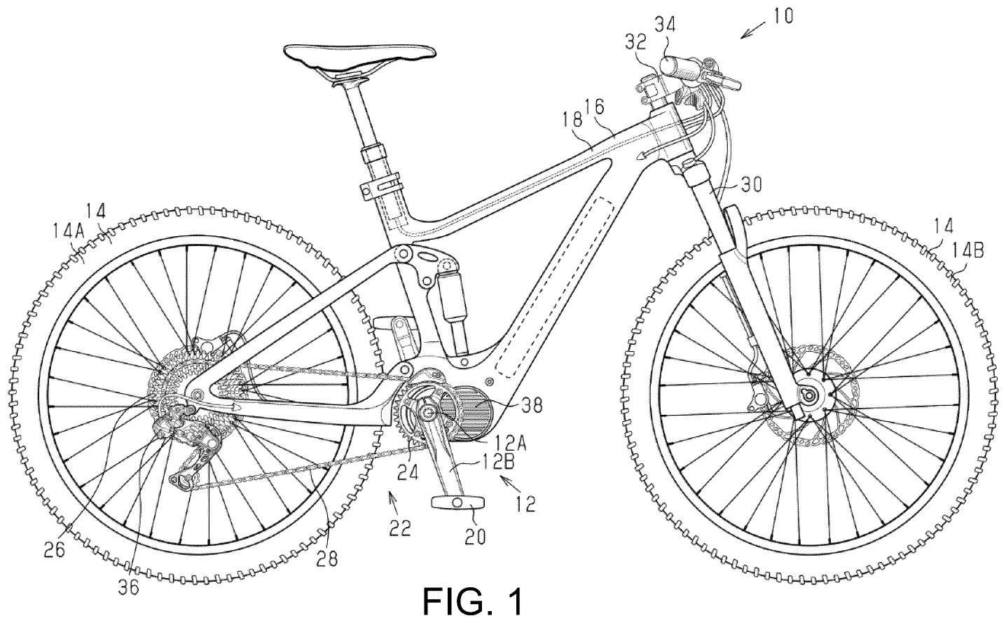

A first embodiment of a control device 60 for a human-powered vehicle 10 will now be described with reference to FIGS. 1 to 4.

The human-powered vehicle 10 is a vehicle including at least one wheel and driven by at least a human driving force. The human-powered vehicle 10 includes, for example, various types of bicycles such as a mountain bike, a road bike, a city bike, a cargo bike, a hand bike, and a recumbent bike. The number of wheels on the human-powered vehicle 10 is not limited. The human-powered vehicle 10 includes, for example, a unicycle and a vehicle including two or more wheels. The human-powered vehicle 10 is not limited to a vehicle configured to be driven only by a human driving force. The human-powered vehicle 10 includes an E-bike that uses a driving force of an electric motor in addition to a human driving force for propulsion. The E-bike includes an electric assist bicycle that assists in propulsion with an electric motor. In the embodiments described below, the human-powered vehicle 10 refers to a bicycle.

In this specification, the frame of reference for the terms indicating directions such as “front,” “rear,” “frontward,” “rearward,” “left,” “right,” “sideward,” “upward,” and “downward,” as well as other analogous terms indicating directions will be based on the view of a rider who is facing the handlebar from a reference position (e.g., on saddle or seat) of the human-powered vehicle.

As shown in FIG. 1, the human-powered vehicle 10 includes, for example, a crank 12 to which a human driving force is input. The human-powered vehicle 10 includes, for example, a wheel 14 and a vehicle body 16. The wheel 14 includes, for example, a drive wheel 14A and a coasting wheel 14B. The drive wheel 14A is, for example, a rear wheel of the human-powered vehicle 10. The vehicle body 16 includes, for example, a frame 18. The crank 12 includes, for example, a crank axle 12A rotatable relative to the frame 18 and two crank arms 12B respectively provided on axial ends of the crank axle 12A. Two pedals 20 are coupled to the crank arms 12B. The drive wheel 14A is, for example, driven in accordance with rotation of the crank 12. The drive wheel 14A is, for example, supported by the frame 18.

The crank 12 is, for example, linked to the drive wheel 14A by a drive mechanism 22. The drive mechanism 22 includes, for example, a first rotary body 24 coupled to the crank axle 12A. The crank axle 12A and the first rotary body 24 can be coupled so as to rotate integrally with each other or can be coupled via a first one-way clutch. In an example, the first one-way clutch is configured to rotate the first rotary body 24 forward in a case where the crank 12 rotates forward. In an example, the first one-way clutch is configured to allow rotation of the crank 12 relative to the first rotary body 24 in a case where the crank 12 rotates rearward. The first rotary body 24 includes, for example, a sprocket, a pulley, or a bevel gear. The drive mechanism 22 further includes, for example, a second rotary body 26 and a linking member 28. The linking member 28 transmits rotational force of the first rotary body 24 to the second rotary body 26. The linking member 28 includes, for example, a chain, a belt, or a shaft.

The second rotary body 26 is, for example, coupled to the drive wheel 14A. The second rotary body 26 includes, for example, a sprocket, a pulley, or a bevel gear. For example, a second one-way clutch is provided in a human driving force transmission path between the second rotary body 26 and the drive wheel 14A. In an example, the second one-way clutch is configured to rotate the drive wheel 14A forward in a case where the second rotary body 26 rotates forward. In an example, the second one-way clutch is configured to allow rotation of the second rotary body 26 relative to the drive wheel 14A in a case where the second rotary body 26 rotates rearward.

The coasting wheel 14B is, for example, coupled to the frame 18 by a front fork 30. The coasting wheel 14B is, for example, a front wheel of the human-powered vehicle 10. A handlebar 34 is coupled to the front fork 30 by a stem 32. In the present embodiment, the drive wheel 14A is linked to the crank 12 by the drive mechanism 22. Any one of the drive wheel 14A and the coasting wheel 14B can be linked to the crank 12 by the drive mechanism 22.

The human-powered vehicle 10 includes, for example, a transmission device 36, a motor 38, a first detector 40, and a second detector 42.

The transmission device 36, for example, shifts a transmission ratio that is a ratio of a wheel rotational speed of the drive wheel 14A of the human-powered vehicle 10 to a crank rotational speed of the crank axle 12A of the human-powered vehicle 10. The transmission device 36 includes, for example, at least one of a front derailleur, a rear derailleur, and an internal shifting device. In a case where the transmission device 36 includes an internal shifting device, the internal shifting device is provided, for example, on a hub of the drive wheel 14A. The transmission device 36 is, for example, configured to be actuated by an actuator 44. The actuator 44 includes, for example, an electric actuator. The actuator 44 includes, for example, an electric motor.

The motor 38 is, for example, configured to apply a propulsion force to the human-powered vehicle 10. The motor 38 includes, for example, one or more electric motors. The motor 38 is, for example, configured to transmit rotation to at least one of the coasting wheel 14B and the human driving force transmission path extending from the pedals 20 to the drive wheel 14A. The human driving force transmission path includes, for example, the drive wheel 14A. The motor 38 is, for example, provided on the frame 18 and configured to transmit a rotational force of the motor 38 to the first rotary body 24.

The human-powered vehicle 10 includes, for example, a drive unit. The drive unit includes, for example, the motor 38 and a housing. The motor 38 is, for example, provided on the housing. The housing is, for example, provided on the frame 18. The housing is, for example, detachably coupled to the frame 18. For example, a third one-way clutch is provided in the force transmission path between the motor 38 and the crank axle 12A. The third one-way clutch, for example, transmits rotational force of the motor 38 to the first rotary body 24 while restricting transmission of rotational force of the crank axle 12A to the motor 38. In a case where the motor 38 is provided on at least one of the drive wheel 14A and the coasting wheel 14B, the motor 38 can include a hub motor.

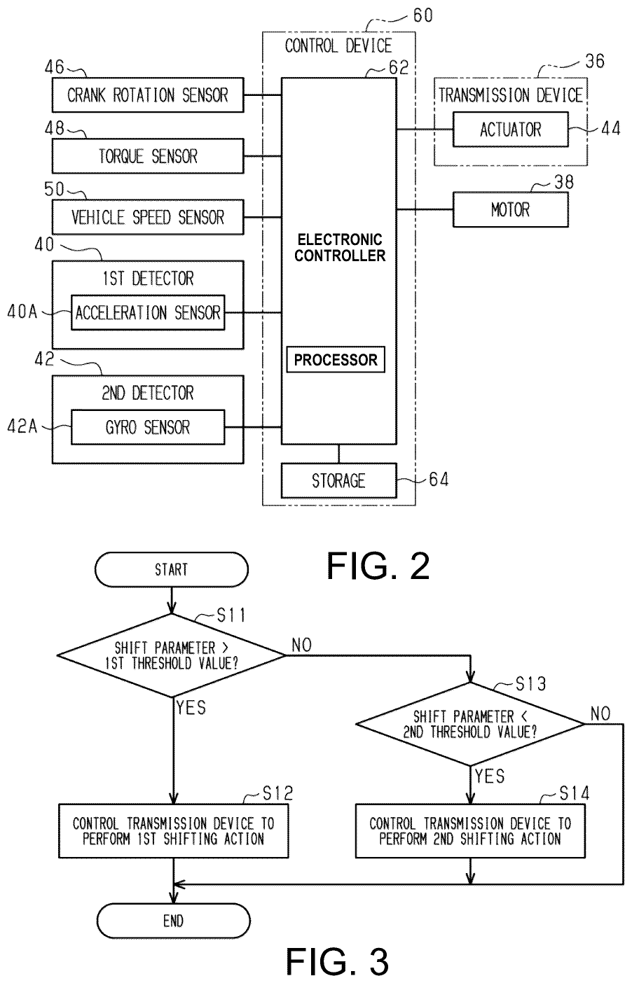

As shown in FIG. 2, the human-powered vehicle 10 further includes one or more detectors or sensors for detecting one or more traveling conditions of the human-powered vehicle 10. The terms “detector” and “sensors” as used herein refers to a hardware device or instrument designed to detect the presence or absence of a particular event, object, substance, or a change in its environment, and to emit a signal in response. The terms “detector” and “sensors” as used herein do not include a human being. The human-powered vehicle 10 includes, for example, an inclination angle detector. The inclination angle detector is configured to detect gradient of the road on which the human-powered vehicle 10 is traveling. The gradient is, for example, calculated by the inclination angle in the direction in which the human-powered vehicle 10 is traveling. The gradient corresponds to, for example, the inclination angle of the human-powered vehicle 10. The inclination angle detector includes, for example, the first detector 40 and the second detector 42. The inclination angle detector is, for example, electrically connected to a controller 62 by a wire or in a wireless manner.

The first detector 40 includes, for example, an acceleration sensor 40A. The acceleration sensor 40A is, for example, configured to detect an acceleration of the human-powered vehicle 10. The acceleration sensor 40A is, for example, electrically connected to the electronic controller 62 by a wire or in a wireless manner.

The acceleration sensor 40A is, for example, configured to detect an acceleration of the human-powered vehicle 10 with respect to a first axis. The first axis includes, for example, an axis in a front-rear direction of the human-powered vehicle 10 in a state in which the front wheel and the rear wheel of the human-powered vehicle 10 are in contact with a level surface so that the human-powered vehicle 10 stands upright on the level surface. The acceleration with respect to the first axis corresponds to, for example, a first acceleration.

The acceleration sensor 40A can be configured to detect at least one of an acceleration with respect to a second axis and an acceleration with respect to a third axis. The second axis is, for example, an axis in a sideward direction of the human-powered vehicle 10 in a state in which the front wheel and the rear wheel of the human-powered vehicle 10 are in contact with a level surface so that the human-powered vehicle 10 stands upright on the level surface. The acceleration with respect to the second axis corresponds to, for example, a second acceleration. The third axis is, for example, an axis extending in a vertical direction in a state in which the front wheel and the rear wheel of the human-powered vehicle 10 are in contact with a level surface so that the human-powered vehicle 10 stands upright on the level surface. The acceleration with respect to the third axis corresponds to, for example, a third acceleration.

The second detector 42 includes, for example, a gyro sensor 42A. The gyro sensor 42A is, for example, configured to detect an angular velocity of the human-powered vehicle 10. The gyro sensor 42A is, for example, electrically connected to the electronic controller 62 by a wire or in a wireless manner.

The gyro sensor 42A is, for example, configured to detect the angular velocity of the human-powered vehicle 10 with respect to the second axis. The second axis is, for example, orthogonal to the first axis. The gyro sensor 42A can be configured to detect at least one of the angular velocity with respect to the first axis and the angular velocity with respect to the third axis. The angular velocity with respect to the second axis is, for example, the angular velocity about the pitch axis. The angular velocity with respect to the first axis is, for example, the angular velocity about the roll axis. The angular velocity with respect to the third axis is, for example, the angular velocity about the yaw axis.

The human-powered vehicle 10 includes, for example, a crank rotation sensor 46. The crank rotation sensor 46 is, for example, configured to detect information corresponding to the crank rotational speed of the crank axle 12A. The crank rotation sensor 46 outputs, for example, a signal corresponding to the crank rotational speed of the crank axle 12A. The crank rotation sensor 46 is, for example, provided on the frame 18 of the human-powered vehicle 10.

The crank rotation sensor 46 includes, for example, a magnetic sensor. The magnetic sensor, for example, outputs a signal corresponding to the strength of a magnetic field. For example, an annular magnet is provided on the crank axle 12A, a member configured to rotate in cooperation with the crank axle 12A, or the force transmission path extending from the crank axle 12A to the first rotary body 24. The annular magnet has a magnetic field the strength of which varies in a circumferential direction. The magnet can be provided on a member configured to rotate integrally with the crank axle 12A in the human driving force transmission path extending from the crank axle 12A to the first rotary body 24. In a case where the first one-way clutch is not provided between the crank axle 12A and the first rotary body 24, the magnet can be provided on the first rotary body 24.

The crank rotation sensor 46 can include, for example, an optical sensor, an acceleration sensor, a gyro sensor, or a torque sensor instead of the magnetic sensor. The crank rotation sensor 46 is, for example, electrically connected to the electronic controller 62 by a wire or in a wireless manner.

The crank rotation sensor 46 is, for example, configured to output a detection signal a predetermined number of times in one rotation of the crank 12. The predetermined number of times is, for example, two or greater. The predetermined number of times is, for example, four or greater. The predetermined number of times is, for example, a multiple of four. In an example, the predetermined number of times is 8, 12, or 16. The crank rotation sensor 46 can include a vehicle speed sensor. In a case where the crank rotation sensor 46 includes a vehicle speed sensor, the electronic controller 62 is, for example, configured to calculate the crank rotational speed of the crank axle 12A from the transmission ratio and a vehicle speed detected by the vehicle speed sensor.

The human-powered vehicle 10 includes, for example, a torque sensor 48. The torque sensor 48 is, for example, configured to output a signal corresponding to torque of human driving force input to the crank axle 12A. In a case where, for example, the first one-way clutch is provided in the force transmission path, the torque sensor 48 is provided in the force transmission path at an upstream side of the first one-way clutch. The torque sensor 48 is, for example, provided on a member included in the force transmission path or a member near the member included in the force transmission path. The member included in the force transmission path is, for example, the crank axle 12A, a member that transmits human driving force between the crank axle 12A and the first rotary body 24, the crank arms 12B, or the pedals 20.

The torque sensor 48 includes, for example, a strain sensor, a magnetostrictive sensor, or a pressure sensor. The strain sensor includes, for example, a strain gauge. The torque sensor 48 is, for example, electrically connected to the electronic controller 62 by a wire or in a wireless manner. The torque sensor 48 can have any configuration as long as information related to a human driving force is obtained. The torque sensor 48 can include a sensor that detects pressure applied to the pedals 20, a sensor that detects tension on the chain, or the like.

The human-powered vehicle 10 includes, for example, a vehicle speed sensor 50. The vehicle speed sensor 50 is, for example, configured to detect information corresponding to rotational speed of the wheel 14. The vehicle speed sensor 50 is configured to detect, for example, a magnet provided on the wheel 14 of the human-powered vehicle 10. The vehicle speed sensor 50, for example, outputs a signal corresponding to a rotational speed of the wheel 14. The electronic controller 62 calculates, for example, a vehicle speed of the human-powered vehicle 10 based on the rotational speed of the wheel 14 and information related to the circumferential length of the wheel 14. In an example, the storage 64 stores the information related to the circumferential length of the wheel 14.

The vehicle speed sensor 50 detects, for example, a wheel rotational speed of the drive wheel 14A. The vehicle speed sensor 50 is, for example, electrically connected to the electronic controller 62 by a wire or in a wireless manner. The vehicle speed sensor 50, for example, outputs information corresponding to the wheel rotational speed of the drive wheel 14A.

The vehicle speed sensor 50 detects, for example, rotation of an annular element provided on the drive wheel 14A of the human-powered vehicle 10. The annular element includes, for example, parts being detected arranged in the circumferential direction. The detected parts include, for example, grooves or holes. The vehicle speed sensor 50, for example, outputs a signal corresponding to the wheel rotational speed of the drive wheel 14A based on passage of the detected parts on the annular element.

The vehicle speed sensor 50 is formed of, for example, a coil and a magnetic pole. Rotation of the annular element changes the magnetic flux extending through the coil and generates AC voltage that is detected as the wheel rotational speed of the drive wheel 14A. The vehicle speed sensor 50 includes, for example, a Hall element. The vehicle speed sensor 50 is not limited to the configuration that detects the detected parts provided on the drive wheel 14A. The vehicle speed sensor 50 can include a magnetic reed that forms a reed switch, an optical sensor, or the like.

The vehicle speed sensor 50 is configured to, for example, output a detection signal a predetermined number of times in one rotation of the drive wheel 14A. The predetermined number of times is, for example, two or greater. The predetermined number of times is, for example, four or greater. The predetermined number of times is, for example, a multiple of four. The predetermined number of times is, for example, thirty or greater. In an example, the vehicle speed sensor 50 is configured to detect the detected parts sixty times or more in a case where the drive wheel 14A completes a single rotation.

The control device 60 for the human-powered vehicle includes, for example, the electronic controller 62. The electronic controller 62 is formed of one or more semiconductor chips that are mounted on a circuit board. Thus, the terms “electronic controller” and “controller” as used herein refers to hardware that executes a software program, and does not include a human being. The electronic controller 62 is, for example, configured to control at least one of the transmission device 36 and the motor 38. The electronic controller 62 includes, for example, one or more processors that execute predetermined control programs. The processor includes, for example, a central processing unit (CPU) or a micro processing unit (MPU). The processor can be provided at separate positions. The electronic controller 62 can include one or more microcomputers.

The control device 60 further includes, for example, the storage 64. The storage 64 stores, for example, various control programs and information used for various control processes. The storage 64 includes, for example, a non-volatile memory and a volatile memory. The nonvolatile memory includes, for example, at least one of read-only memory (ROM), erasable programmable read only memory (EPROM), electrically erasable programmable read-only memory (EEPROM), and flash memory. The volatile memory includes, for example, a random access memory (RAM). The storage 64 is any computer storage device or any non-transitory computer-readable medium with the sole exception of a transitory, propagating signal.

The electronic controller 62 is, for example, configured to control a component for the human-powered vehicle 10. The component includes, for example, the transmission device 36 and the motor 38. The electronic controller 62 is, for example, configured to control the motor 38. The electronic controller 62 is, for example, configured to drive the motor 38 in accordance with at least one of a human driving force and a rotational speed of the crank axle 12A in a case where the vehicle speed of the human-powered vehicle 10 is less than a predetermined vehicle speed. The predetermined vehicle speed is, for example, determined by regulations in each country. The predetermined vehicle speed is, for example, 24 km/h, 25 km/h, 30 km/h, 32 km/h, or 45 km/h.

The electronic controller 62 is, for example, configured to control the motor 38 so that an assist force produced by the motor 38 equals a predetermined assist force. The assist force includes, for example, at least one of an output of the motor 38, an upper limit value of the output of the motor 38, and an assist ratio that is a ratio of the output of the motor 38 to the human driving force applied to the crank axle 12A.

A human driving force is, for example, expressed as at least one of a human torque, which is torque of the human driving force, and a human power, which is a power of the human driving force. The human power is, for example, the product of a torque applied to the crank axle 12A and a rotational speed of the crank axle 12A.

The output of the motor 38 is, for example, expressed as at least one of a motor torque, which is a torque of an output of the motor 38, and a motor power, which is a power of an output of the motor 38. The assist ratio can be a ratio of the motor torque to the human torque or can be a ratio of the motor power to the human power.

The electronic controller 62 is, for example, configured to control the transmission device 36. The electronic controller 62 is, for example, configured to control the transmission device 36 so as to shift the transmission ratio in accordance with a shift parameter PS related to the human-powered vehicle 10. The electronic controller 62 is, for example, configured to control the transmission device 36 so as to shift the transmission ratio in accordance with at least one of the crank rotational speed, a human driving force input to the crank 12, and the vehicle speed of the human-powered vehicle 10. The shift parameter PS includes, for example, at least one of the crank rotational speed, the human driving force input to the crank 12, and the vehicle speed of the human-powered vehicle 10.

The electronic controller 62 is, for example, configured to control the transmission device 36 so as to shift the transmission ratio in accordance with a comparison of the shift parameter PS related to the human-powered vehicle 10 with a threshold value S. The electronic controller 62 is, for example, configured to control the transmission device 36 so as to shift the transmission ratio based on a comparison of at least one of the crank rotational speed, the human driving force, and the vehicle speed with the threshold value S. The threshold value S includes, for example, a first threshold value S1. The electronic controller 62 is, for example, configured to control the transmission device 36 so as to perform a first shifting action that increases the transmission ratio in a case where the shift parameter PS is greater than the first threshold value S1. The threshold value S includes, for example, a second threshold value S2. The electronic controller 62 is, for example, configured to control the transmission device 36 so as to perform a second shifting action that decreases the transmission ratio in a case where the shift parameter PS is less than the second threshold value S2. In an example, the first threshold value S1 is greater than the second threshold value S2.

The shift parameter PS can include a parameter other than the crank rotational speed, the human driving force input to the crank 12, and the vehicle speed of the human-powered vehicle 10. In an example, the shift parameter PS includes at least one of a parameter correlated with the crank rotational speed and a parameter correlated with the load on the rider. The parameter correlated with the crank rotational speed includes, for example, at least one of a rotational speed of the first rotary body 24, a rotational speed of the second rotary body 26, a moving speed of the linking member 28, and the vehicle speed. The parameter correlated with the load on the rider includes, for example, at least one of a human driving force and an inclination angle of the human-powered vehicle 10.

In a case where the shift parameter PS includes the crank rotational speed, for example, the electronic controller 62 is configured to control the transmission device 36 so as to perform the first shifting action in a case where the crank rotational speed is greater than the first threshold value S1. In a case where the shift parameter PS includes the crank rotational speed, for example, the electronic controller 62 is configured to control the transmission device 36 so as to perform the second shifting action in a case where the crank rotational speed is less than the second threshold value S2.

In a case where the shift parameter PS includes human driving force, for example, the electronic controller 62 is configured to control the transmission device 36 so as to perform the first shifting action in a case where the human driving force is greater than the first threshold value S1. In a case where the shift parameter PS includes the human driving force, for example, the electronic controller 62 is configured to control the transmission device 36 so as to perform the second shifting action in a case where the human driving force is less than the second threshold value S2.

In a case where the shift parameter PS includes vehicle speed, for example, the electronic controller 62 is configured to control the transmission device 36 so as to perform the first shifting action in a case where vehicle speed is greater than the first threshold value S1. In a case where the shift parameter PS includes vehicle speed, for example, the electronic controller 62 is configured to control the transmission device 36 so as to perform the second shifting action in a case where the vehicle speed is less than the second threshold value S2.

A process executed by the electronic controller 62 for controlling the transmission device 36 so as to shift the transmission ratio in accordance with a comparison of the shift parameter PS with the threshold value S will now be described with reference to FIG. 3. In a case where the electronic controller 62 is supplied with electric power, the electronic controller 62 starts the process and proceeds to step S11 of the flowchart illustrated in FIG. 3. Upon completion of the flowchart illustrated in FIG. 3, the electronic controller 62 repeats the process from step S11 in predetermined cycles until the supply of electric power is stopped.

In step S11, the electronic controller 62 determines whether the shift parameter PS is greater than the first threshold value S1. In a case where the shift parameter PS is greater than the first threshold value S1, the electronic controller 62 proceeds to step S12. In step S12, the electronic controller 62 controls the transmission device 36 so as to perform the first shifting action and then ends the process.

In step S11, in a case where the shift parameter PS is less than or equal to the first threshold value S1, the electronic controller 62 proceeds to step S13. In step S13, the electronic controller 62 determines whether the shift parameter PS is less than the second threshold value S2. In a case where the shift parameter PS is less than the second threshold value S2, the electronic controller 62 proceeds to step S14. In step S14, the electronic controller 62 controls the transmission device 36 so as to decrease the transmission ratio and then ends the process. In a case where the shift parameter PS is greater than or equal to the second threshold value S2, the electronic controller 62 ends the process.

The electronic controller 62 is, for example, configured to control the transmission device 36 so as to restrict the first shifting action that increases the transmission ratio in a case where a pitch change amount, which is a change amount of a pitch angle of the human-powered vehicle 10, is greater than or equal to a first change amount. In a case where the pitch change amount is greater than or equal to the first change amount, the electronic controller 62 is, for example, configured to control the transmission device 36 so as to restrict the first shifting action and not restrict the second shifting action that decreases the transmission ratio. In a case where the pitch change amount is greater than or equal to the first change amount, the electronic controller 62 is, for example, configured to control the transmission device 36 so as not to restrict the second shifting action in the same manner as a case where the pitch change amount is less than the first change amount. In an example, in a case where a predetermined condition including a case where the pitch change amount is greater than or equal to the first change amount is satisfied to restrict the first shifting action, the second shifting action is performed in the same manner as in a case where the predetermined coition is not satisfied.

The first change amount has, for example, a value that can be used to determine a frontal lift of the human-powered vehicle 10. In a case of determining that the human-powered vehicle 10 is in a frontal lift state based on the pitch change amount, the electronic controller 62 is, for example, configured to control the transmission device 36 so as to restrict the first shifting action. The first change amount is, for example, an amount of change per first predetermined time. The first predetermined time is, for example, greater than zero seconds and less than two seconds. The first predetermined time is, for example, one second. The first change amount is, for example, an amount of change per one second. The first change amount is, for example, greater than or equal to fifteen degrees and less than or equal to twenty-five degrees. The first change amount is, for example, twenty degrees.

The electronic controller 62 is, for example, configured to restrict the first shifting action by increasing the threshold value S in a case where the pitch change amount is greater than or equal to the first change amount. The electronic controller 62 is, for example, configured to restrict the first shifting action by increasing the first threshold value S1 in a case where the pitch change amount is greater than or equal to the first change amount. The electronic controller 62 is, for example, configured not restrict the second shifting action without changing the second threshold value S2 in a case where the pitch change amount is greater than or equal to the first change amount.

The electronic controller 62 is, for example, configured to control the transmission device 36 so as to restrict the first shifting action based on the pitch change amount and at least one of the crank rotational speed, human driving force, and vehicle. The electronic controller 62 is, for example, configured to control the transmission device 36 so as to restrict the first shifting action and not restrict the second shifting action based on the pitch change amount and at least one of the crank rotational speed, human driving force, and vehicle speed.

The electronic controller 62 is, for example, configured to control the transmission device 36 to restrict the first shifting action in a case where the pitch change amount is greater than or equal to the first change amount and a crank rotational speed change amount, which is a change amount of the crank rotational speed, is greater than or equal to the predetermined crank rotational speed change amount. The electronic controller 62 is, for example, configured to control the transmission device 36 so as to restrict the first shifting action and not restrict the second shifting action in a case where the pitch change amount is greater than or equal to the first change amount and the crank rotational speed change amount is greater than or equal to the predetermined crank rotational speed change amount. The predetermined crank rotational speed change amount is, for example, a change amount per second predetermined time. The second predetermined time is, for example, greater than zero seconds and less than two seconds. The second predetermined time is, for example, one second. The predetermined crank rotational speed change amount is, for example, a change amount per one second. The predetermined crank rotational speed change amount is, for example, set to a value that allows for determination that the rider has started vigorously pressing the pedals 20 to overcome a step. The predetermined crank rotational speed change amount is, for example, greater than or equal to 20 rpm and less than or equal to 40 rpm. The predetermined crank rotational speed change amount is, for example, 30 rpm. The predetermined crank rotational speed change amount includes, for example, a predetermined crank rotational speed increase amount. The predetermined crank rotational speed change amount can include a predetermined crank rotational speed decrease amount.

The electronic controller 62 can be, for example, configured to control the transmission device 36 to restrict the first shifting action in a case where the pitch change amount is greater than or equal to the first change amount and the crank rotational speed is greater than or equal to the predetermined crank rotational speed change amount. The electronic controller 62 can be, for example, configured to control the transmission device 36 so as to restrict the first shifting action and not restrict the second shifting action in a case where the pitch change amount is greater than or equal to the first change amount and the crank rotational speed is greater than or equal to the predetermined crank rotational speed. The predetermined crank rotational speed can be greater than the first threshold value S1, can be less than the first threshold value S1, and can be equal to the first threshold value S1. The predetermined crank rotational speed is, for example, set to a value that allows for determination that the rider is vigorously pressing the pedals 20 to overcome a step. The predetermined crank rotational speed is, for example, greater than or equal to 80 rpm and less than or equal to 150 rpm. The predetermined crank rotational speed is, for example, 90 rpm.

The electronic controller 62 is, for example, configured to control the transmission device 36 so as to restrict the first shifting action upon the pitch change amount being greater than or equal to the first change amount in a case where the pitch angle increases. The electronic controller 62 is, for example, configured to control the transmission device 36 so as to restrict the first shifting action upon the pitch change amount being greater than or equal to the first change amount and the crank rotational speed change amount being greater than or equal to the predetermined crank rotational speed change amount in a case where the pitch angle increases. The electronic controller 62 is, for example, configured to control the transmission device 36 so as to restrict the first shifting action and not restrict the second shifting action upon the pitch change amount being greater than or equal to the first change amount and the crank rotational speed change amount being greater than or equal to the predetermined crank rotational speed change amount in a case where the pitch angle increases.

The electronic controller 62 can be configured to control the transmission device 36 so as to restrict the first shifting action upon the pitch change amount being greater than or equal to the first change amount in a case where the pitch angle increases. The electronic controller 62 can be, for example, configured to control the transmission device 36 so as to restrict the first shifting action upon the pitch change amount being greater than or equal to the first change amount and the crank rotational speed change amount being greater than or equal to the predetermined crank rotational speed change amount in a case where the pitch angle decreases. The electronic controller 62 can be, for example, configured to control the transmission device 36 so as to restrict the first shifting action and not restrict the second shifting action upon the pitch change amount is greater than or equal to the first change amount and the crank rotational speed change amount being greater than or equal to the predetermined crank rotational speed change amount in a case where the pitch angle decreases.

The electronic controller 62, for example, calculates the inclination angle of the human-powered vehicle 10 from an output of the first detector 40 and an output of the second detector 42. The electronic controller 62 is, for example, configured to calculate an inclination change amount from the angular velocity detected by the gyro sensor 42A and an estimated value of the inclination angle that is calculated based on the acceleration detected by the acceleration sensor 40A. The electronic controller 62, for example, calculates the inclination change amount from the angular velocity and the estimated value of the inclination angle calculated based on the acceleration. This increases the accuracy of the inclination change amount, which is used to control the component of the human-powered vehicle 10.

The inclination angle includes, for example, a pitch angle of the human-powered vehicle 10. The inclination change amount includes, for example, a pitch change amount of the pitch angle. The electronic controller 62 is, for example, configured to calculate the pitch angle based on an output of the first detector 40 that is configured to detect a pitch angle and an output of the second detector 42 that differs from the first detector 40 and is configured to detect a pitch angle. The electronic controller 62 calculates an estimated value of the pitch angle from, for example, acceleration detected by the acceleration sensor 40A of the first detector 40. The electronic controller 62 is, for example, configured to calculate a pitch change amount from the angular velocity detected by the gyro sensor 42A and an estimated value of the pitch angle that is calculated based on the acceleration detected by the acceleration sensor 40A.

The electronic controller 62 is configured to calculate an estimated value of a pitch angle from, for example, acceleration detected by the first detector 40. The electronic controller 62 is, for example, configured to calculate a translational acceleration caused by acceleration and deceleration of the vehicle by differentiating the vehicle speed detected by the vehicle speed sensor 50. The electronic controller 62 is configured to calculate an estimated value of the pitch angle from, for example, the translational acceleration and a first acceleration detected by the acceleration sensor 40A. In an example, the electronic controller 62 calculates an estimated value of the pitch angle in each third predetermined time. The third predetermined time is, for example, greater than zero seconds and less than one second. The third predetermined time is, for example, 0.01 seconds.

The electronic controller 62 can be, for example, configured to correct the pitch angle calculated from the angular velocity detected by the gyro sensor 42A based on an estimated value of the pitch angle detected by the acceleration sensor 40A. The electronic controller 62 can be further configured to use the corrected pitch angle as the pitch angle. The electronic controller 62 can be, for example, configured to correct an estimated value of the pitch angle detected by the acceleration sensor 40A based on the pitch angle calculated from the angular velocity detected by the gyro sensor 42A. The electronic controller 62 can be further configured to use the corrected pitch angle as the pitch angle. The electronic controller 62 can be, for example, configured to use, as the pitch angle, the smaller one of an estimated value of a pitch angle detected by the acceleration sensor 40A and a pitch angle calculated from the angular velocity detected by the gyro sensor 42A. The electronic controller 62 can be, for example, configured to use, as the pitch angle, the larger one of an estimated value of a pitch angle detected by the acceleration sensor 40A and a pitch angle calculated from the angular velocity detected by the gyro sensor 42A.

The inclination angle can include, for example, at least one of the yaw angle of the human-powered vehicle 10 and the roll angle of the human-powered vehicle 10 instead of or in addition to the pitch angle of the human-powered vehicle 10. In a case where the inclination angle includes a yaw angle, the electronic controller 62, for example, calculates an estimated value of the yaw angle from the second acceleration and an output of a sensor configured to detect a sideward movement amount of the human-powered vehicle 10. In a case where the inclination angle includes a yaw angle, the inclination change amount includes, for example, a yaw change amount of a yaw angle. In a case where the inclination angle includes a roll angle, the electronic controller 62, for example, calculates an estimated value of a roll angle from the third acceleration and an output of a sensor configured to detect a vertical movement amount of the human-powered vehicle 10. In a case where the inclination angle includes a roll angle, the inclination change amount includes, for example, a roll change amount of a roll angle.

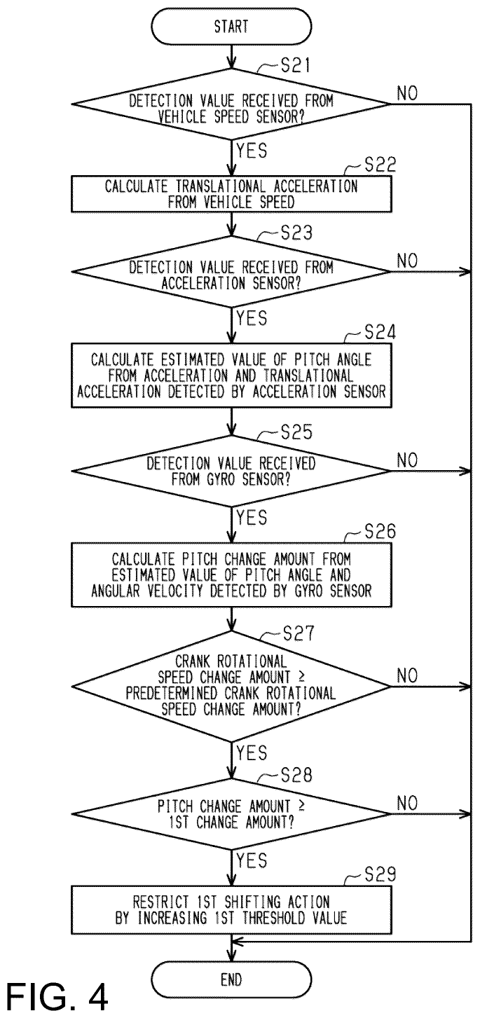

A process executed by the electronic controller 62 for restricting the first shifting action in accordance with the pitch change amount will now be described with reference to FIG. 4. In a case where the electric power is supplied to the electronic controller 62, the electronic controller 62 starts the process and proceeds to step S21 of the flowchart shown in FIG. 4. In a case in which the flowchart shown in FIG. 4 ends, the electronic controller 62 repeats the process from step S21 after a predetermined interval until the supply of electric power is stopped.

In step S21, the electronic controller 62 determines whether a detection value is received from the vehicle speed sensor 50. The detection value of the vehicle speed sensor 50 includes, for example, information related to a vehicle speed of the human-powered vehicle 10. In a case where the detection value is received from the vehicle speed sensor 50, the electronic controller 62 proceeds to step S22. In a case where the detection value is not received from the vehicle speed sensor 50, the electronic controller 62 ends the process. In step S22, the electronic controller 62 calculates a translational acceleration from the vehicle speed and proceeds to step S23.

In step S23, the electronic controller 62 determines whether a detection value is received from the acceleration sensor 40A. The detection value of the acceleration sensor 40A includes, for example, at least one of the first acceleration, the second acceleration, and the third acceleration. In a case where, for example, at least one of the first acceleration, the second acceleration, and the third acceleration is received from the acceleration sensor 40A, the electronic controller 62 determines that the detection value is received from the acceleration sensor 40A. In the present embodiment, in a case where all of the first acceleration, the second acceleration, and the third acceleration are received from the acceleration sensor 40A, the electronic controller 62 determines that the detection value is received from the acceleration sensor 40A. In a case where the detection value is received from the acceleration sensor 40A, the electronic controller 62 proceeds to step S24. In a case where the detection value is not received from the acceleration sensor 40A, the electronic controller 62 ends the process.

In step S24, the electronic controller 62 calculates an estimated value of the pitch angle from the translational acceleration and the acceleration detected by the acceleration sensor 40A and proceeds to step S25. In step S25, the electronic controller 62 determines whether a detection value is received from the gyro sensor 42A. The detection value of the gyro sensor 42A includes, for example, the angular velocity related to the second axis of the human-powered vehicle 10. In a case where the detection value is received from the gyro sensor 42A, the electronic controller 62 proceeds to step S26. In a case where the detection value is not received from the gyro sensor 42A, the electronic controller 62 ends the process.

In step S26, the electronic controller 62 calculates the pitch change amount from the estimated value of the pitch angle and the angular velocity detected by the gyro sensor 42A and proceeds to step S27. In step S27, the electronic controller 62 determines whether the crank rotational speed change amount is greater than or equal to the predetermined crank rotational speed change amount. In a case where the crank rotational speed change amount is greater than or equal to the predetermined crank rotational speed change amount, the electronic controller 62 proceeds to step S28. In a case where the crank rotational speed change amount is less than the predetermined crank rotational speed change amount, the electronic controller 62 ends the process.

In step S28, the electronic controller 62 determines whether the pitch change amount is greater than or equal to the first change amount. In a case where the pitch change amount is greater than or equal to the first change amount, the electronic controller 62 proceeds to step S29. In a case where the pitch change amount is less than the first change amount, the electronic controller 62 ends the process. In step S29, the electronic controller 62 restricts the first shifting action by increasing the first threshold value S1 and then ends the process.

In an example, after restricting the first shifting action in step S29, the electronic controller 62 stops restriction of the first shifting action in a case a return condition is satisfied. In a case where the return condition is satisfied, the electronic controller 62, for example, changes the first threshold value S1 to the first threshold value S1 used before being changed in step S29. The return condition is satisfied, for example, in a case where a predetermined period ends. The return condition can be satisfied in a case where the pitch change amount is less than or equal to a predetermined change amount that is less than the first change amount.

Step S23 can be executed next to step S21. In this case, after step S21, the electronic controller 62 sequentially executes steps S23, S22, and S24 and then proceeds to step S25. Step S23 can be executed before step S21. In this case, the electronic controller 62 sequentially executes steps S23, S22, and S24 and then proceeds to step S25.

Step S25 can be executed before step S21. In this case, the electronic controller 62 sequentially executes steps S25, S21, S22, S23, and S24 and then proceeds to step S26. Step S25 can be executed next to step S21. In this case, the electronic controller 62 sequentially executes steps S21, S25, S22, S23, and S24 and then proceeds to step S26.

Step S25 can be executed next to step S22. In this case, the electronic controller 62 sequentially executes steps S21, S22, S25, S23, and S24 and then proceeds to step S26. Step S25 can be executed next to step S23. In this case, the electronic controller 62 sequentially executes steps S21, S22, S23, S25, and S24 and then proceeds to step S26.

Step S27 can be executed next to step S28. In this case, after step S26, the electronic controller 62 sequentially executes steps S28 and S27 and then proceeds to step S29. Step S27 can be omitted. In this case, after step S26, the electronic controller 62 proceeds to step S28.

The inclination change amount can be increased, for example, in a case where the human-powered vehicle 10 is traveling on a difficult section of the road. In a case where a frontal part of the human-powered vehicle 10 is lifted to overcome a step and the pitch change amount becomes greater than or equal to the first change amount, the crank rotational speed can be increased by, for example, the rider further pressing the pedals 20 to overcome the step. In this case, if the crank rotational speed becomes greater than the first threshold value S1 and causes the transmission device 36 to perform the first shifting action, the load on the rider will be increased. In this regard, in a case where the inclination change amount is large, the electronic controller 62 increases the first threshold value S1. Thus, the crank rotational speed is less likely to exceed the first threshold value S1. In a case where the inclination change amount is large, the electronic controller 62 controls the transmission device 36 to restrict the first shifting action, the load on the rider is less likely to be increased by a temporary increase in the crank rotational speed.

### Second Embodiment

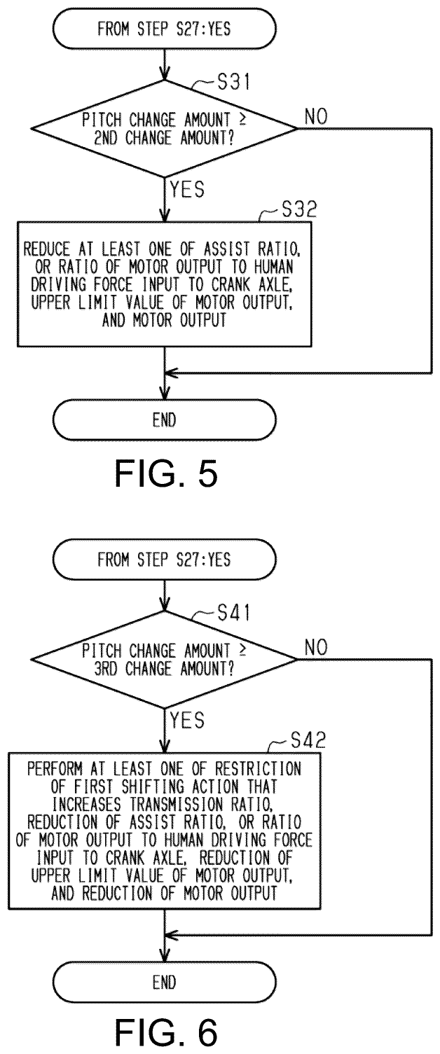

A second embodiment of a control device 60 will now be described with reference to FIGS. 4 and 5. The control device 60 of the second embodiment is the same as the control device 60 of the first embodiment except that the electronic controller 62 controls the motor 38 instead of the transmission device 36 in accordance with the inclination change amount. Same reference characters are given to those elements that are the same as the corresponding elements of the first embodiment. Such elements will not be described in detail.

The electronic controller 62 is, for example, configured to reduce at least one of an assist ratio that is a ratio of an output of the motor 38 to the human driving force applied to the crank axle 12A, an upper limit value of the output of the motor 38, and the output of the motor 38 in a case where the inclination change amount, which is a change amount of an inclination angle of the human-powered vehicle 10, is greater than or equal to a second change amount. The electronic controller 62 is, for example, configured to reduce at least one of an assist ratio that is a ratio of a motor torque to a human torque, an upper limit value of the motor torque, and the motor torque in a case where the inclination change amount is greater than or equal to the second change amount. The electronic controller 62 is, for example, configured to reduce at least one of an assist ratio that is a ratio of a motor power to a human power, an upper limit value of the motor power, and the motor power in a case where the inclination change amount is greater than or equal to the second change amount. The second change amount is, for example, the first change amount. The second change amount can differ from the first change amount.

The electronic controller 62 is, for example, configured to reduce at least one of an assist ratio, an upper limit value of an output of the motor 38, and the output of the motor 38 upon the inclination change amount being greater than or equal to the second change amount in a case where the inclination angle increases. The electronic controller 62 is, for example, configured to reduce at least one of an assist ratio that is a ratio of a motor torque to a human torque, an upper limit value of the motor torque, and the motor torque upon the inclination change amount being greater than or equal to the second change amount in a case where the inclination angle increases. The electronic controller 62 is, for example, configured to reduce at least one of an assist ratio that is a ratio of a motor power to a human power, an upper limit value of the motor power, and the motor power upon the inclination change amount being greater than or equal to the second change amount in a case where the inclination angle increases.

The electronic controller 62 is, for example, configured to reduce at least one of an assist ratio, an upper limit value of an output of the motor 38, and the output of the motor 38 upon the inclination change amount being greater than or equal to the second change amount in a case where the inclination angle decreases. The electronic controller 62 is, for example, configured to reduce at least one of an assist ratio that is a ratio of a motor torque to a human torque, an upper limit value of the motor torque, and the motor torque upon the inclination change amount being greater than or equal to the second change amount in a case where the inclination angle decreases. The electronic controller 62 is, for example, configured to reduce at least one of an assist ratio that is a ratio of a motor power to a human power, an upper limit value of the motor power, and the motor power upon the inclination change amount being greater than or equal to the second change amount in a case where the inclination angle decreases.

The electronic controller 62 is, for example, configured to reduce at least one of an assist ratio, an upper limit value, and output of the motor 38 in a case where the pitch change amount is greater than or equal to the second change amount. The electronic controller 62 is, for example, configured to reduce at least one of an assist ratio that is a ratio of a motor torque to a human torque, an upper limit value of the motor torque, and the motor torque in a case where the pitch change amount is greater than or equal to the second change amount. The electronic controller 62 is, for example, configured to reduce at least one of an assist ratio that is a ratio of a motor power to a human power, an upper limit value of the motor power, and the motor power in a case where the pitch change amount is greater than or equal to the second change amount.

The electronic controller 62 is, for example, configured to reduce at least one of an assist ratio, an upper limit value, and output of the motor 38 upon the pitch change amount being greater than or equal to the second change amount in a case where the inclination angle increases. The electronic controller 62 is, for example, configured to reduce at least one of an assist ratio that is a ratio of a motor torque to a human torque, an upper limit value of the motor torque, and the motor torque upon the pitch change amount being greater than or equal to the second change amount in a case where the inclination angle increases. The electronic controller 62 is, for example, configured to reduce at least one of an assist ratio that is a ratio of a motor power to a human power, an upper limit value of the motor power, and the motor power upon the pitch change amount being greater than or equal to the second change amount in a case where the inclination angle increases.

The electronic controller 62 is, for example, configured to reduce at least one of an assist ratio, an upper limit value, and output of the motor 38 upon the pitch change amount being greater than or equal to the second change amount in a case where the inclination angle decreases. The electronic controller 62 is, for example, configured to reduce at least one of an assist ratio that is a ratio of a motor torque to a human torque, an upper limit value of the motor torque, and the motor torque upon the pitch change amount being greater than or equal to the second change amount in a case where the inclination angle decreases. The electronic controller 62 is, for example, configured to reduce at least one of an assist ratio that is a ratio of a motor power to a human power, an upper limit value of the motor power, and the motor power upon the pitch change amount being greater than or equal to the second change amount in a case where the inclination angle decreases.

A process executed by the electronic controller 62 for reducing at least one of an assist ratio, an upper limit value, and output of the motor 38 in accordance with the pitch change amount will now be described with reference to FIGS. 4 and 5. In a case where the electric power is supplied to the electronic controller 62, the electronic controller 62 starts the process and proceeds to step S21 of the flowchart shown in FIG. 4. Upon completion of the flowchart shown in FIGS. 4 and 5, the electronic controller 62 repeats the process from step S21 in predetermined cycles until the supply of electric power is stopped.

The electronic controller 62 executes steps S21 to S27 in the same manner as the electronic controller 62 of the first embodiment and then proceeds to step S31. In step S31, the electronic controller 62 determines whether the pitch change amount is greater than or equal to the second change amount. In a case where the pitch change amount is greater than or equal to the second change amount, the electronic controller 62 proceeds to step S32. In a case where the pitch change amount is less than the second change amount, the electronic controller 62 ends the process. In step S32, the electronic controller 62 reduces at least one of an assist ratio that is a ratio of an output of the motor 38 to a human driving force input to the crank axle 12A, an upper limit value of the output of the motor 38, and the output of the motor 38.

In an example, after reducing at least one of an assist ratio that is a ratio of an output of the motor 38 to a human driving force input to the crank axle 12A, an upper limit value of the output of the motor 38, and the output of the motor 38 in step S32, if the return condition is satisfied, the electronic controller 62 stops the reduction of at least one of the assist ratio, which is output of the motor 38 to a human driving force input to the crank axle 12A, the upper limit value of the output of the motor 38, and the output of the motor 38. In a case where the return condition is satisfied, the electronic controller 62, for example, changes the first threshold value S1 to the first threshold value S1 used before being changed in step S32. The return condition is satisfied, for example, in a case where a predetermined period ends. The return condition can be satisfied in a case where the pitch change amount is less than or equal to a predetermined change amount that is less than the first change amount.

Step S31 can be executed before step S27. In this case, after step S26, the electronic controller 62 sequentially executes steps S31 and S27. Step S27 can be omitted. In this case, after step S26, the electronic controller 62 executes step S31.

In the present embodiment, the electronic controller 62 reduces at least one of the assist ratio, the upper limit value of an output of the motor 38, and the output of the motor 38, for example, in a case where a frontal part of the human-powered vehicle 10 is lifted to overcome a step and the pitch change amount becomes greater than or equal to the first change amount and then the human-powered vehicle 10 overcomes the step. This allows the rider to stably operate the vehicle body 16.

### Third Embodiment

A third embodiment of a control device 60 will now be described with reference to FIGS. 4 and 6. The control device 60 of the third embodiment is the same as the control device 60 of the first embodiment except that the electronic controller 62 controls the transmission device 36 and the motor 38 in accordance with the inclination change amount. The same reference characters are given to those elements that are the same as the corresponding elements of the first and second embodiments. Such elements will not be described in detail.

The electronic controller 62 is, for example, configured to perform at least one of a restriction of a first shifting action that increases the transmission ratio, a reduction of an assist ratio that is a ratio of an output of the motor 38 to the human driving force applied to the crank axle 12A, a reduction of an upper limit value of the output of the motor 38, and a reduction of the output of the motor 38 in a case where an inclination change amount that is a change amount of the inclination angle is greater than equal to a third change amount. The electronic controller 62 is, for example, configured to perform at least one of a restriction of the first shifting action that increases the transmission ratio, a reduction of an assist ratio that is a ratio of a motor torque to a human torque, a reduction of the upper limit value of the motor torque, and a reduction of the motor torque in a case where the inclination change amount, which is a change amount of the inclination angle of the human-powered vehicle 10, is greater than equal to the third change amount. The electronic controller 62 is, for example, configured to perform at least one of a restriction of the first shifting action that increases the transmission ratio, a reduction of an assist ratio that is a ratio of a motor power to a human power, a reduction of the upper limit value of the motor power, and a reduction of the motor power in a case where the inclination change amount, which is a change amount of the inclination angle of the human-powered vehicle 10, is greater than equal to the third change amount.

The electronic controller 62 is, for example, configured to perform at least one of a restriction of the first shifting action, a reduction of the assist ratio, a reduction of the upper limit value of an output of the motor 38, and a reduction of the output of the motor 38 upon the inclination change amount being greater than or equal to the third change amount in a case where the inclination angle increases. The electronic controller 62 is, for example, configured to perform at least one of a restriction of the first shifting action that increases the transmission ratio, a reduction of an assist ratio that is a ratio of a motor torque to a human torque, a reduction of the upper limit value of the motor torque, and a reduction of the motor torque upon the inclination change amount, which is a change amount of the inclination angle of the human-powered vehicle 10, being greater than equal to the third change amount in a case where the inclination angle increases. The electronic controller 62 is, for example, configured to perform at least one of a restriction of the first shifting action that increases the transmission ratio, a reduction of an assist ratio that is a ratio of a motor power to a human power, a reduction of the upper limit value of the motor power, and a reduction of the motor power upon the inclination change amount, which is a change amount of the inclination angle of the human-powered vehicle 10, being greater than equal to the third change amount in a case where the inclination angle increases.

The electronic controller 62 is, for example, configured to perform at least one of a restriction of the first shifting action, a reduction of the assist ratio, a reduction of the upper limit value of an output of the motor 38, and a reduction of the output of the motor 38 upon the inclination change amount being greater than or equal to the third change amount in a case where the inclination angle decreases. The electronic controller 62 is, for example, configured to perform at least one of a restriction of the first shifting action that increases the transmission ratio, a reduction of an assist ratio that is a ratio of a motor torque to a human torque, a reduction of the upper limit value of the motor torque, and a reduction of the motor torque upon the inclination change amount, which is a change amount of the inclination angle of the human-powered vehicle 10, being greater than equal to the third change amount in a case where the inclination angle decreases. The electronic controller 62 is, for example, configured to perform at least one of a restriction of the first shifting action that increases the transmission ratio, a reduction of an assist ratio that is a ratio of a motor power to a human power, a reduction of the upper limit value of the motor power, and reduction of the motor power upon the inclination change amount, which is a change amount of the inclination angle of the human-powered vehicle 10, being greater than equal to the third change amount in a case where the inclination angle decreases.

A process executed by the electronic controller 62 for performing at least one of a restriction of the first shifting action of the transmission device 36, a reduction of an assist ratio of the motor 38, a reduction of an upper limit value of an output of the motor 38, and a reduction of an output of the motor 38 in accordance with the pitch change amount will now be described with reference to FIGS. 4 and 6. In a case where the electric power is supplied to the electronic controller 62, the electronic controller 62 starts the process and proceeds to step S21 of the flowchart shown in FIG. 4. Upon completion of the flowchart shown in FIGS. 4 and 6, the electronic controller 62 repeats the process from step S21 in predetermined cycles until the supply of electric power is stopped.

The electronic controller 62 executes steps S21 to S27 in the same manner as the electronic controller 62 of the first embodiment and then proceeds to step S41. In step S41, the electronic controller 62 determines whether the pitch change amount is greater than or equal to the third change amount. In a case where the pitch change amount is greater than or equal to the third change amount, the electronic controller 62 proceeds to step S42. In a case where the pitch change amount is less than the third change amount, the electronic controller 62 ends the process. In step S42, the electronic controller 62 performs at least one of a restriction of the first shifting action that increases the transmission ratio, a reduction of an assist ratio that is a ratio of an output of the motor 38 to a human driving force input to the crank axle 12A, a reduction of an upper limit value of an output of the motor 38, and a reduction of an output of the motor 38 and then ends the process.

In an example, after performing at least one of a restriction of the first shifting action, a reduction of an assist ratio that is a ratio of an output of the motor 38 to a human driving force input to the crank axle 12A, a reduction of an upper limit value of an output of the motor 38, and a reduction of the output of the motor 38 in step S42, if the return condition is satisfied, the electronic controller 62 stops the performance of at least one of restriction of the first shifting action, a reduction of the assist ratio, which is a ratio of an output of the motor 38 to a human driving force input to the crank axle 12A, a reduction of the upper limit value of an output of the motor 38, and a reduction of the output of the motor 38. In a case where the return condition is satisfied, the electronic controller 62, for example, changes the first threshold value S1 to the first threshold value S1 used before being changed in step S42. The return condition is satisfied, for example, in a case where a predetermined period ends. The return condition can be satisfied in a case where the pitch change amount is less than or equal to a predetermined change amount that is less than the first change amount.

Step S41 can be executed before step S27. In this case, after step S26, the electronic controller 62 sequentially executes steps S41 and S27. Step S27 can be omitted. In this case, after step S26, the electronic controller 62 executes step S41.

### Modifications

The description related with the above embodiments exemplifies, without any intention to limit, applicable forms of a control device for a human-powered vehicle according to the present disclosure. The human-powered vehicle control device according to the present disclosure can be applied to, for example, modifications of the embodiments that are described below and combinations of at least two of the modifications that do not contradict each other. In the following modifications, the same reference characters are given to those components that are the same as the corresponding components of the above embodiments. Such components will not be described in detail.

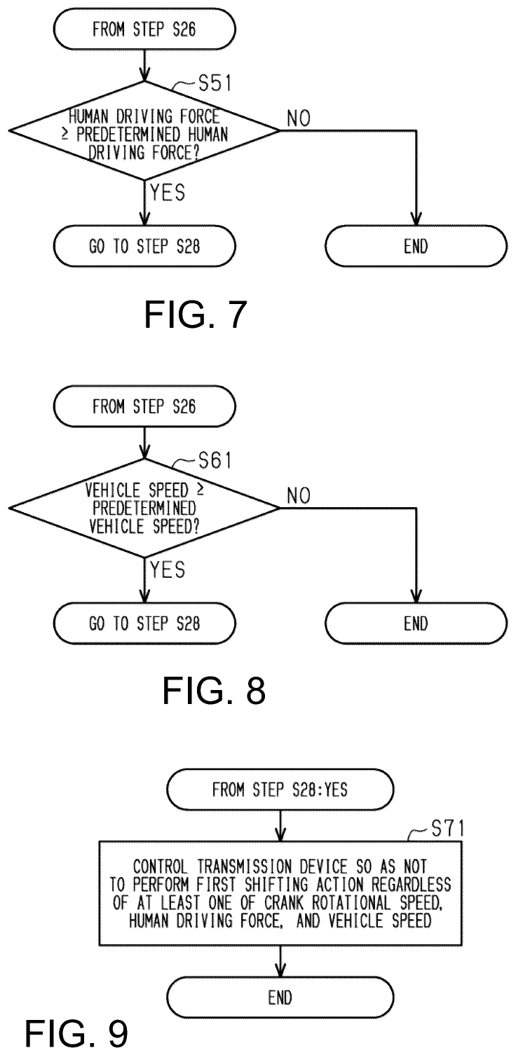

The electronic controller 62 can be configured to control the transmission device 36 to restrict the first shifting action in a case where the pitch change amount is greater than or equal to the first change amount and human driving force input to the crank axle 12A is greater than or equal to a predetermined human driving force. The predetermined human driving force is, for example, set to a value that allows for determination that the rider is pressing the pedals 20. The predetermined human driving force is, for example, greater than or equal to 20 Nm and less than or equal to 40 Nm. The predetermined human driving force is, for example, 30 Nm. As shown in FIG. 7, the electronic controller 62 executes step S51 instead of step S27. After step S26, the electronic controller 62 proceeds to step S51. In step S51, the electronic controller 62 determines whether human driving force is greater than or equal to the predetermined human driving force. In a case where human driving force is greater than or equal to the predetermined human driving force, the electronic controller 62 proceeds to step S28. In a case where human driving force is less than the predetermined human driving force, the electronic controller 62 ends the process. In addition to step S27, the electronic controller 62 can execute step S51. In this case, step S27 can be executed next to step S26 or S51.

The electronic controller 62 can be configured to control the transmission device 36 to restrict the first shifting action in a case where the pitch change amount is greater than or equal to the first change amount and the vehicle speed of the human-powered vehicle 10 is greater than or equal to a predetermined vehicle speed. As shown in FIG. 8, the electronic controller 62 executes step S61 instead of step S27. After step S26, the electronic controller 62 proceeds to step S61. In step S61, the electronic controller 62 determines whether the vehicle speed is greater than or equal to the predetermined vehicle speed. In a case where the vehicle speed is greater than or equal to the predetermined vehicle speed, the electronic controller 62 proceeds to step S28. In a case where the vehicle speed is less than the predetermined vehicle speed, the electronic controller 62 ends the process. In addition to step S27, the electronic controller 62 can execute step S61. In this case, step S27 can be executed next to step S26 or S61.

The electronic controller 62 can be configured not to perform the first shifting action in a case where the pitch change amount is greater than or equal to the first change amount regardless of the crank rotational speed, the human driving force, and the vehicle speed. In an example, the electronic controller 62 is configured to control the transmission device 36 so as not to perform the first shifting action in a case where the pitch change amount is greater than or equal to the first change amount regardless of the crank rotational speed, the human driving force, and the vehicle speed. In an example, the electronic controller 62 prohibits the first shifting action in a case where the pitch change amount is greater than or equal to the first change amount. As shown in FIG. 9, the electronic controller 62 executes step S71 instead of step S29. After step S28, the electronic controller 62 proceeds to step S71. In step S71, the electronic controller 62 controls the transmission device 36 so as not to perform the first shifting action regardless of at least one of the crank rotational speed, the human driving force, and the vehicle speed. In an example, after controlling the transmission device 36 so as not to perform the first shifting action regardless of the crank rotational speed, the human driving force, and the vehicle speed in step S71, if the return condition is satisfied, the electronic controller 62 ends the controlling of the transmission device 36 so as not to perform the first shifting action regardless of the crank rotational speed, the human driving force, and the vehicle speed. The return condition is satisfied, for example, in a case where a predetermined period ends. The return condition can be satisfied in a case where the pitch change amount is less than or equal to a predetermined change amount that is less than the first change amount.

The human-powered vehicle 10 can include a global navigation satellite system (GNSS) receiver. The GNSS receiver includes, for example, a global positioning system (GPS) receiver. The electronic controller 62 calculates an inclination angle of the road on which the human-powered vehicle 10 is traveling based on, for example, GPS information obtained from the GPS receiver and gradients of road surfaces included in map information stored in advance in the storage 64. The GNSS receiver can include a receiver for a satellite positioning system other than GPS. Examples of the satellite positioning system other than the GPS include a quasi-zenith satellite system (QZSS), a global navigation satellite system (GLONASS), Galileo, and the like. The electronic controller 62 can use, for example, a value obtained by subtracting the inclination angle of the road from a pitch angle detected by the inclination angle detector as the pitch angle.

In a modified example in which the human-powered vehicle 10 includes the GNSS receiver, the electronic controller 62 can use an inclination angle of the road as the pitch angle of the human-powered vehicle 10.

Instead of restricting the first shifting action based on an inclination angle calculated from an output of the first detector 40 and an output of the second detector 42, for example, the electronic controller 62 can restrict the first shifting action in a case where both an inclination angle detected by the first detector 40 and an inclination angle detected by the second detector 42 are greater than or equal to the first change amount. Instead of restricting the first shifting action based on an inclination angle calculated from an output of the first detector 40 and an output of the second detector 42, for example, the electronic controller 62 can restrict the first shifting action in a case where at least one of an inclination angle detected by the first detector 40 and an inclination angle detected by the second detector 42 is greater than or equal to the first change amount.

The electronic controller 62 can be configured to restrict the first shifting action, for example, taking into consideration the inclination angle, a change tendency of the crank rotational speed, and a change tendency of human driving force. In an example, in a case where the inclination angle tends to increase and the pitch change amount is equal to the first change amount, the electronic controller 62 restricts the first shifting action. In an example, in a case where the crank rotational speed tends to increase and the pitch change amount is equal to the first change amount, the electronic controller 62 restricts the first shifting action. In an example, in a case where human driving force tends to increase and the pitch change amount is equal to the first change amount, the electronic controller 62 restricts the first shifting action.

As long as the control device 60 for a human-powered vehicle includes the electronic controller 62 configured to control the transmission device 36 to shift a transmission ratio that is a ratio of a wheel rotational speed of the drive wheel 14A of the human-powered vehicle 10 to a crank rotational speed of the crank axle 12A of the human-powered vehicle 10, and the electronic controller 62 is configured to control the transmission device 36 so as to restrict the first shifting action that increases the transmission ratio in a case where a pitch change amount that is a change amount of a pitch angle of the human-powered vehicle 10 is greater than or equal to the first change amount, the remaining configurations can be omitted. In an example, the motor 38 can be omitted from the human-powered vehicle 10.

In the control device 60 for a human-powered vehicle that includes the transmission device 36 configured to shift a transmission ratio that is a ratio of a wheel rotational speed of the drive wheel 14A of the human-powered vehicle 10 to a crank rotational speed of the crank axle 12A of the human-powered vehicle 10, the motor 38 configured to apply propulsion force to the human-powered vehicle 10, the first detector 40 including the acceleration sensor 40A, and the second detector 42 including the gyro sensor 42A, as long as the control device 60 includes the electronic controller 62 configured to control at least one of the transmission device 36 and the motor 38, and the electronic controller 62 is configured to calculate an inclination angle of the human-powered vehicle 10 based on an output of the first detector 40 and an output of the second detector 42 and to perform at least one of a restriction of the first shifting action that increases the transmission ratio, a reduction of an assist ratio that is a ratio of an output of the motor 38 to a human driving force input to the crank 12, a reduction of the upper limit value of an output of the motor 38, and a reduction of the output of the motor 38, in a case where the inclination change amount, which is a change amount of the inclination angle, is greater than the third change amount, the remaining configurations can be omitted.

In this specification, the phrase “at least one of” as used in this disclosure means “one or more” of a desired choice. As one example, the phrase “at least one of” as used in this disclosure means “only one choice” or “both of two choices” in a case where the number of choices is two. In another example, in this specification, the phrase “at least one of” as used in this disclosure means “only one single choice” or “any combination of equal to or more than two choices” if the number of its choices is equal to or more than three.

In this specification, ordinal numbers such as “first, second, and third” are used to merely distinguish between members having the same name and have no particular meaning.

What is claimed is:

1. A control device for a human-powered vehicle, the control device comprising:
an electronic controller configured to control a transmission device, the transmission device being configured to shift a transmission ratio that is a ratio of a wheel rotational speed of a drive wheel of the human-powered vehicle to a crank rotational speed of a crank axle of the human-powered vehicle; and
the electronic controller is configured to control the transmission device so as to restrict a first shifting action that increases the transmission ratio in a case where a pitch change amount is greater than or equal to a first change amount, the pitch change amount being a change amount of a pitch angle of the human-powered vehicle.

2. The control device according to claim 1, wherein
the electronic controller is configured to control the transmission device so as to restrict the first shifting action and not restrict a second shifting action that decreases the transmission ratio in a case where the pitch change amount is greater than or equal to the first change amount.

3. The control device according to claim 2, wherein
the electronic controller is configured to control the transmission device so as to shift the transmission ratio in accordance with at least one of the crank rotational speed, a human driving force applied to the crank axle, and a vehicle speed of the human-powered vehicle.

4. The control device according to claim 3, wherein:
the electronic controller is configured to control the transmission device so as to shift the transmission ratio based on a comparison of the at least one of the crank rotational speed, the human driving force, and the vehicle speed with a threshold value; and
the electronic controller is configured to restrict the first shifting action by increasing the threshold value in a case where the pitch change amount is greater than or equal to the first change amount.

5. The control device according to claim 3, wherein
the electronic controller is configured so as not to perform the first shifting action regardless of the least one of the crank rotational speed, the human driving force, and the vehicle speed in a case where the pitch change amount is greater than or equal to the first change amount.

6. The control device according to claim 1, wherein
the electronic controller is configured to control the transmission device so as to restrict the first shifting action in a case where the pitch change amount is greater than or equal to the first change amount and a crank rotational speed change amount is greater than or equal to a predetermined crank rotational speed change amount, the crank rotational speed change amount being a change amount of the crank rotational speed.

7. The control device according to claim 1, wherein
the electronic controller is configured to control the transmission device so as to restrict the first shifting action in a case where the pitch change amount is greater than or equal to the first change amount and a human driving force applied to the crank axle is greater than or equal to a predetermined human driving force.

8. The control device according to claim 1, wherein
the electronic controller is configured to control the transmission device so as to restrict the first shifting action in a case where the pitch change amount is greater than or equal to the first change amount and a vehicle speed of the human-powered vehicle is greater than or equal to a predetermined vehicle speed.

9. The control device according to claim 1, wherein
the electronic controller is configured to control the transmission device so as to restrict the first shifting action upon the pitch change amount being greater than or equal to the first change amount in a case where the pitch angle increases.

10. The control device according to claim 1, wherein
the electronic controller is configured to control the transmission device so as to restrict the first shifting action upon the pitch change amount being greater than or equal to the first change amount in a case where the pitch angle decreases.

11. The control device according to claim 1, wherein:
the electronic controller configured to control a motor that is configured to apply a propulsion force to the human-powered vehicle,
the electronic controller is configured to reduce at least one of an assist ratio that is a ratio of an output of the motor to a human driving force applied to the crank axle, an upper limit value of the output of the motor, and the output of the motor in a case where an inclination change amount that is a change amount of an inclination angle of the human-powered vehicle is greater than or equal to a second change amount.

12. The control device according to claim 11, wherein:
the inclination angle includes the pitch angle;
the inclination change amount includes the pitch change amount; and
the electronic controller is configured to reduce the at least one of the assist ratio, the upper limit value, and the output of the motor in a case where the pitch change amount is greater than or equal to a second change amount.

13. The control device according to claim 11, wherein
the second change amount is the first change amount.

14. The control device according to claim 1, wherein
the electronic controller is configured to calculate the pitch angle based on an output of a first detector that is configured to detect the pitch angle and an output of a second detector that differs from the first detector and is configured to detect the pitch angle.

15. The control device according to claim 14, wherein
the first detector includes an acceleration sensor.

16. The control device according to claim 14, wherein
the second detector includes a gyro sensor.

17. A control device for a human-powered vehicle including a transmission device, a motor, a first detector including an acceleration sensor, and a second detector including a gyro sensor, the transmission device being configured to shift a transmission ratio that is a ratio of a wheel rotational speed of a drive wheel of the human-powered vehicle to a crank rotational speed of a crank axle of the human-powered vehicle, and the motor being configured to apply a propulsion force to the human-powered vehicle, the control device comprising:
an electronic controller configured to control at least one of the transmission device and the motor;
the electronic controller being configured to calculate an inclination angle of the human-powered vehicle from an output of the first detector and an output of the second detector; and
the electronic controller being configured to perform at least one of a restriction of a first shifting action that increases the transmission ratio, a reduction of an assist ratio that is a ratio of an output of the motor to a human driving force applied to the crank axle, a reduction of an upper limit value of the output of the motor, and a reduction of the output of the motor in a case where an inclination change amount that is a change amount of the inclination angle is greater than or equal to a third change amount.

18. The control device according to claim 17, wherein:
the acceleration sensor is configured to detect acceleration related to a first axis of the human-powered vehicle;
the gyro sensor is configured to detect angular velocity related to a second axis of the human-powered vehicle;
the second axis is orthogonal to the first axis; and
the electronic controller is configured to calculate the inclination change amount from the angular velocity detected by the gyro sensor and an estimated value of the inclination angle that is calculated based on the acceleration detected by acceleration sensor.

19. The control device according to claim 18, wherein:
the inclination angle includes a pitch angle of the human-powered vehicle;
the inclination change amount includes a pitch change amount of the pitch angle; and
the electronic controller is configured to calculate the pitch change amount from the angular velocity detected by the gyro sensor and an estimated value of the pitch angle that is calculated based on the acceleration detected by the acceleration sensor.

20. The control device according to claim 17, wherein
the electronic controller is configured to perform at least one of a restriction of the first shifting action, a reduction of the assist ratio, a reduction of the upper limit value, and a reduction of the output of the motor upon the inclination change amount being greater than or equal to the third change amount in a case where the inclination angle increases.

21. The control device according to claim 17, wherein
the electronic controller is configured to perform at least one of a restriction of the first shifting action, a reduction of the assist ratio, a reduction of the upper limit value, and a reduction of the output of the motor upon the inclination change amount being greater than or equal to the third change amount in a case where the inclination angle decreases.
